(19) United States
(12) Patent Application Publication
(10) Pub. No.: US 2004/0074837 A1
(43) Pub. Date: Apr. 22, 2004

(54) Filter housing

(76) Inventors: Simon Roelof Vasse, Hardenberg (NL); Albert Colijn, Drachten (NL)

Correspondence Address: Richard L Byrne, 700 Koppers Building, 436 Seventh Avenue, Pittsburgh, PA, 15219-1818, US

(21) Appl. No.: 10/433,300

(22) PCT Filed: Nov. 15, 2001
(86) PCT No.: PCT/NL01/00829

(30) Foreign Application Priority Data
Dec. 4, 2000 (NL) 1016793

(51) Int. Cl. B01D 35/00

(52) U.S. Cl. 210/435

(57) ABSTRACT

The invention relates to a filter housing (1), comprising: an extruded tube with at least one expanded end (2); and a bush (3) arranged in the expanded end (2). The invention further relates to a method for manufacturing an above stated filter housing (1), which method comprises the steps of: providing an extruded tube, heating an end of the extruded tube, expanding the end (2) of the tube, arranging a bush (3) in the expanded end (2).

The invention relates to a filter housing for instance for modular filter elements, such as replaceable reverse osmosis filter elements.

Known filter housings for reverse osmosis filter elements consist of a fibre impregnated with a synthetic resin. In order to manufacture such a housing a fibre is wound round a mandrel and then impregnated with a synthetic resin. The drawback of such a housing is that the length is limited by the maximum length of the winding mandrel and the costs of such a fibre tube are particularly high as a result of the production process.

A PVC filter housing has recently also been available on the market, wherein on the end of-the housing a peripheral groove is arranged in the wall of the housing. This takes place by means of a machining operation. The integrity of the synthetic wall is hereby affected and it is therefore necessary to arrange a strengthening bush on the outside. In order to ensure sufficient transmission of force through this strengthening bush, this bush must extend over a considerable length on both sides of the groove. This length is determined by, among other factors., the adhesive force of the bush on the outer wall of the housing. The drawback of such a housing is that additional material is required because of the strengthening bush, that a machining operation must be performed in the housing and that, owing to the length of the strengthening bush, the housing is extra-long whereby additional build-in length is required.

It is the object of the invention to obviate the above stated drawbacks.

This object is achieved with a filter housing according to the invention, which comprises:

an extruded tube with at least one expanded end; and

a bush arranged in the expanded end.

The advantage of such a filter housing according to the invention is that the wall of the extruded tube is not damaged by machining operations, whereby the housing wall retains its full strength. The bush arranged in the expanded end enables the forming of a groove in which a locking ring can be arranged in order to thus enclose the filter elements in the housing.

Another advantage of the bush is that it can be made from a material, for instance PET, other than the filter housing. A material can thus be chosen which is better suited for the part in which the groove is arranged.

Extruded tube is readily obtainable at a relatively low price and in different pressure classes, while it has sufficient strength to withstand the pressures. In addition, the length of an extrusion tube is unlimited in terms of the production process.

In a preferred embodiment according to the invention the inner wall of the bush lies substantially in the line of the non-expanded inner wall of the extruded tube. Thus is achieved that the filter elements can be placed inside the housing with an unobstructed passage.

In an embodiment according to the invention the bush comprises a peripheral groove. This groove can be arranged for instance by machining and, because the expanded end is arranged round the bush, the strength of the wall of the housing is retained.

In another embodiment the peripheral groove is formed between the bush and the wall.

The tube of the filter housing according to the invention can comprise polyvinyl chloride, polyethylene or polypropylene, or another thermoplastic.

The bush can comprise for example a thermoplastic or a metal, such as aluminum.

The invention further comprises a method for manufacturing a filter housing according to the invention, which method comprises the steps of:

providing an extruded tube;

heating an end of the extruded tube;

expanding the end of the tube;

arranging a bush in the expanded end.

Heating an end of the extruded tube and expanding the end is also designated as flaring. The expanded end of the tube is then designated as a flare.

In a preferred embodiment according to the method, arranging of the bush takes place by glueing.

Applicant assumes that when the filter housing is placed under pressure, whereby an axial force is exerted on the outer end of the filter housing, the expanded end will tend to shrink in diameter. This would correspond with a cylinder of a fabric which can be expanded by exerting a radial force but which will tend to shrink in diameter through applying of an axial force. The connecting parts are hereby clamped fixedly in the flare. In addition, it is assumed that the wall is strengthened by biaxial orientation.

These and other features of the invention are further elucidated with reference to the annexed drawings.

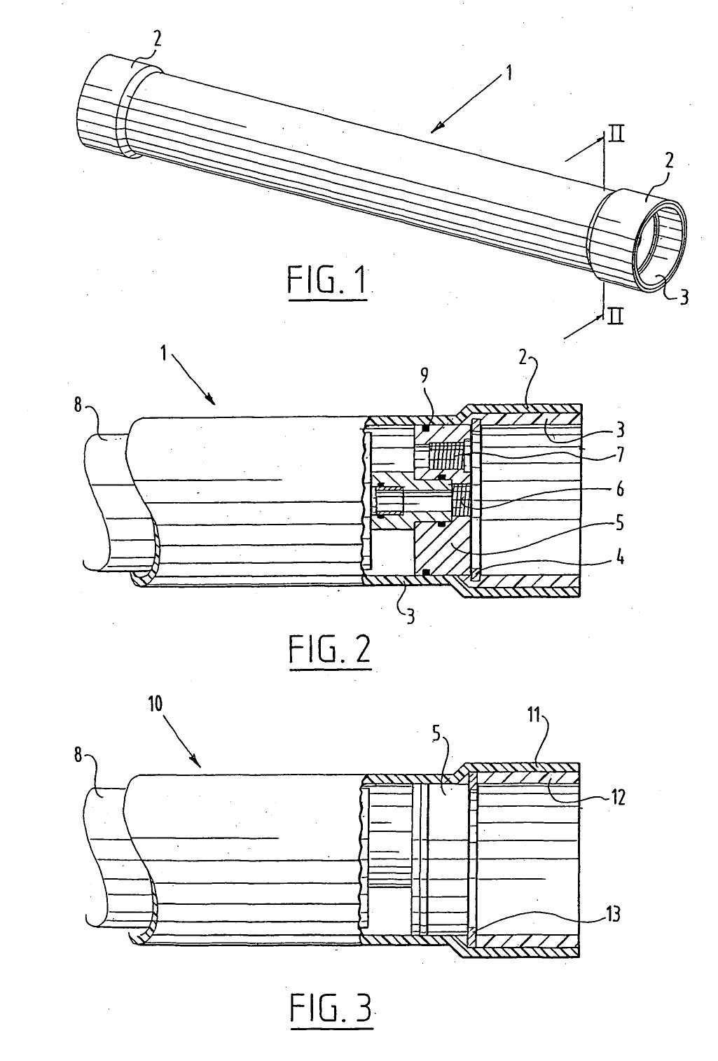

FIG. 1 shows a perspective view of a filter housing according to the invention;

FIG. 2 shows a cross-sectional view along line II-II in FIG. 1;

FIGS. 3-5 show cross-sectional views of embodiments according to the invention.

FIG. 1 shows a filter housing 1 which has an expanded end 2 on each end. A bush 3 is glued into the extruded end 2.

FIG. 2 shows a cross-sectional view of an end 2 of filter housing 1 according to FIG. 1. The wall of the tube is expanded at the position of outer end 2. Bush 3 is arranged herein. In this bush is arranged a groove in which a locking ring 4 is placed. This locking ring 4 locks a connecting part 5 on which are placed connections 6 and 7 for filter elements 8. Connecting part 5 is sealed by means of an O-ring 9 on the inner wall of filter housing 1.

In FIG. 3 is shown a second embodiment of a filter housing 10 according to the invention. Once again placed herein is a filter element 8 which is connected to a connecting piece 5. In the expanded end 11 is placed a bush 12, the length of which-is smaller than the length of expanded part 11. This creates a space in which a locking ring 13 can be placed. The advantage hereof is that a machining operation is no longer necessary in order to arrange a groove in the bush. Locking ring 13 moreover supports on the maximum surface area of bush 12.

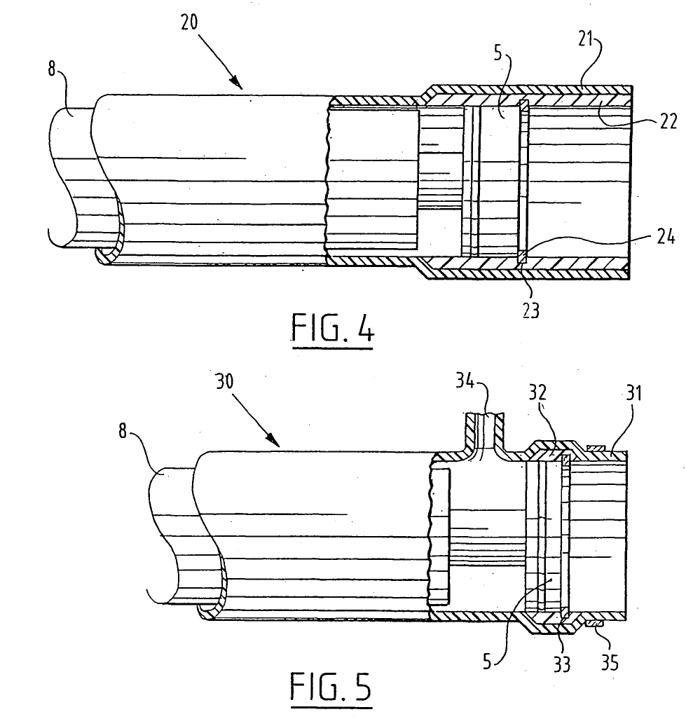

FIG. 4 shows a third embodiment of a filter housing 20 according to the invention. A filter element 8 and a connecting part 5 are once again placed herein. The bush 22 placed in the expanded end 21 has a groove 23 roughly in the centre thereof in which a locking ring 24 is placed. When filter housing 20 comes under pressure, an axial force acts on bush 22. When bush 22 is glued into the expanded end 21, a shearing force will act on the contact surface between the expanded end 21 and bush 22. It will be possible to determine the size of this contact surface subject to the glue strength, the safety factors and the regulations relating to the pressure class. It can hereby be advantageous to arrange the groove roughly in the centre of bush 21.

In FIG. 5 is shown a fourth embodiment of a filter housing 30. In this embodiment a short bush 32 is placed in the expanded end 31, and a peripheral groove 33 is arranged in this bush. Beyond bush 32 the expanded end 33 is narrowed once again so that bush 32 is enclosed. An opening 34 on which a connection can be arranged is further arranged in the wall of the filter housing. When the end of filter housing 30 is heated, this opening 34 can be pressed in simple manner into the wall. A tensioning ring 35 providing extra strength is further arranged on the outermost end of filter housing 30.

Although in FIG. 1 a filter housing is shown wherein both ends are provided with an expanded end, it is also possible to provide the filter housings with one expanded end, thereby enabling mutual connection of a number of such filter housings. The bush is herein formed by the non-expanded outer end of the subsequent filter housing. A modular system thus results, whereby filter housings of any desired length can be manufactured.

It is moreover possible to embody the groove as a helical groove, whereby the locking ring is no longer necessary. The connecting piece can then be screwed into the bush.

Finally, the bush could be embodied as a segmented bush or a multi-layer bush. A segmented bush has its advantages during assembly and disassembly of a filter device, incorporating a filter housing according to the invention.

With a multi-layer bush, the surfaces of the bush could for example be adapted to their function. The outer surface could be made of a material, which could easily be glued to the tube, while the inner surface could be made of a material which can be machined easily.

1. Combination of a filter housing, comprising:
an extruded tube with at least one expanded end;
a bush arranged in the expanded end;
at least a filter element arranged in the filter housing; and
locking means arranged to the bush for locking the filter element in the housing.

2. Combination as claimed in claim 1, wherein the inner wall of the bush lies substantially in the line of the non-expanded inner wall of the extruded tube.

3. Combination as claimed in claim 1 or 2, wherein the bush comprises a peripheral groove.

4. Combination as claimed in any of the foregoing claims, wherein at least the tube comprises polyvinyl chloride, polyethylene, polypropylene or another thermoplastic.

5. Method for manufacturing a filter housing as claimed in any of the foregoing claims, which method comprises the steps of:
providing an extruded tube;
heating an end of the extruded tube;
expanding the end of the tube;
arranging a bush in the expanded end.

6. Method as claimed in claim 5, wherein arranging of the bush takes place by glueing.

7. Method as claimed in claim 5 or 6, wherein after heating the end of the extruded tube an opening is formed in the heated wall.
